(19) United States
(12) Patent Application Publication
(10) Pub. No.: US 2022/0028641 A1
(43) Pub. Date: Jan. 27, 2022

(54) ELECTROMAGNETIC RELAY

(71) Applicant: Panasonic Intellectual Property Management Co., Ltd., Osaka (JP)

(72) Inventor: KATSUTOSHI YAMAGATA, Hokkaido (JP)

(21) Appl. No.: 17/293,519

(22) PCT Filed: Oct. 10, 2019
(86) PCT No.: PCT/JP2019/039943

§ 371 Date: May 13, 2021

(51) Int. Cl. H01H 50/02; H01H 50/12; H01H 50/36; H01H 50/60

(52) U.S. Cl. CPC H01H 50/023; H01H 50/60; H01H 50/36; H01H 50/12

(57) ABSTRACT

An electromagnetic relay of the present disclosure includes a fixed terminal having a fixed contact, a movable contactor having a movable contact, a movable portion that moves the movable contactor between a first position and a second position, an electromagnet device that drives the movable portion, a contact container that contains the fixed contact and the movable contact, a housing that contains the contact container and has a first opening, a sealing material disposed in a path communicating with an outside of the electromagnetic relay, the path being between the housing and the contact container, and a heat conductive member disposed in a first region surrounded by the contact container, the housing, and the sealing material. When the movable contactor is at the first position, the fixed contact is not in contact with the movable contact, when the movable contactor is at the second position, the fixed contact is in contact with the movable contact, and a part of the fixed terminal is exposed to the outside from the first opening.

### TECHNICAL FIELD

The present disclosure relates to an electromagnetic relay in general, and more particularly, relates to an electromagnetic relay including a movable portion that moves a movable contactor between a state where a fixed contact is not in contact with a movable contact and a state where the fixed contact is in contact with the movable contact, and an electromagnet device that drives the movable portion.

### BACKGROUND ART

In PTL 1, there has been disclosed an electromagnetic relay including a drive device including a winding and a coil bobbin, a contact point device driven by the drive device, a lead wire electrically connected to the winding, and a housing that contains the drive device and the contact point device.

### CITATION LIST

### Patent Literature

PTL 1: Unexamined Japanese Patent Publication No. 2017-195097

### SUMMARY OF THE INVENTION

When a particularly large current is passed through the electromagnetic relay, Joule heat generated in contacts becomes hard to release.

An object of the present disclosure is to provide an electromagnetic relay that easily releases Joule heat generated in contacts.

An electromagnetic relay according to one aspect of the present disclosure includes: a fixed terminal having a fixed contact; a movable contactor having a movable contact; a movable portion that moves the movable contactor between a first position and a second position; an electromagnet device that drives the movable portion; a contact container that contains the fixed contact and the movable contact; a housing that contains the contact container and has a first opening; a sealing material disposed in a path communicating with an outside of the electromagnetic relay between the housing and the contact container; and a heat conductive member disposed in a first region surrounded by the contact container, the housing, and the sealing material. When the movable contactor is at the first position, the fixed contact is not in contact with the movable contact, when the movable contactor is at the second position, the fixed contact is in contact with the movable contact, and a part of the fixed terminal is exposed to the outside from the first opening.

According to one aspect of the present disclosure, it is possible to obtain an electromagnetic relay that easily releases Joule heat generated in the contacts.

### BRIEF DESCRIPTION OF DRAWINGS

FIG. 1 is a perspective view of an electromagnetic relay according to a first exemplary embodiment of the present disclosure.

FIG. 2 is a cross-sectional view of the same electromagnetic relay.

FIG. 3 is a partially cutaway perspective view of the same electromagnetic relay.

FIG. 4 is a perspective view of the same electromagnetic relay as viewed from a lower surface side.

FIG. 5 is an exploded perspective view of the same electromagnetic relay as viewed from the lower surface side.

FIG. 6 is a perspective view of an electromagnetic relay according to a second exemplary embodiment of the present disclosure.

FIG. 7 is a partially cutaway perspective view of the same electromagnetic relay.

FIG. 8 is a perspective view of the same electromagnetic relay as viewed from a lower surface side.

FIG. 9 is an exploded perspective view of the same electromagnetic relay as viewed from the lower surface side.

### DESCRIPTION OF EMBODIMENT

Hereinafter, exemplary embodiments of the present disclosure will be described.

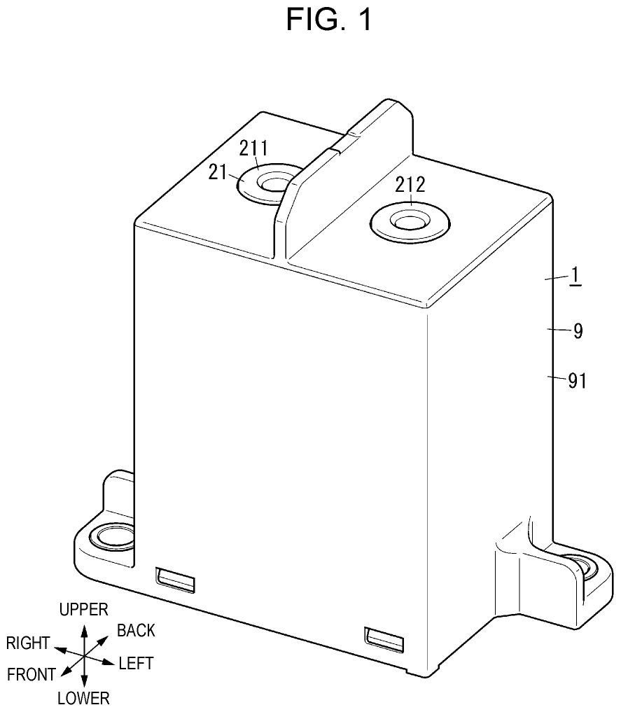

Electromagnetic relay 1 according to the present exemplary embodiment includes fixed terminal 21, movable contactor 24, movable portion 3, electromagnet device 5, contact container 4, housing 9, space 81 (hereinafter, also referred to as first space 81), sealing materials 7, and heat conductive member 6 (see FIG. 1). Fixed terminal 21 has fixed contact 22. Movable contactor 24 has movable contact 25. Movable portion 3 moves movable contactor 24 with respect to fixed terminal 21 between a non-contact position where fixed contact 22 is not in contact with movable contact 25 and a contact position where fixed contact 22 is in contact with movable contact 25. Electromagnet device 5 drives movable portion 3. Contact container 4 contains fixed contact 22 of fixed terminal 21 and movable contactor 24. Housing 9 contains contact container 4 and has exposure opening 95 to expose fixed terminal 21 to an outside through exposure opening 95. First space 81 is between an inner surface of housing 9 and contact container 4. Sealing materials 7 shield first space 81 from an outside of housing 9 for first space 81 not to communicate with the outside of housing 9 via exposure opening 95. Heat conductive member 6 is disposed in first space 81.

In the present exemplary embodiment, even if Joule heat is generated due to a current flowing between movable contactor 24 and fixed terminal 21 at the contact position, the Joule heat is easily released to the outside of electromagnetic relay 1 from contact container 4 through heat conductive member 6 and housing 9.

Further, in the case where heat conductive member 6 or a raw material of heat conductive member 6 is disposed in first space 81 when heat conductive member 6 is manufactured, sealing materials 7 can make it hard for heat conductive member 6 or its raw material to leak out from first space 81 to the outside of housing 9. Therefore, in the present exemplary embodiment, it is possible to obtain electromagnetic relay 1 that easily releases the Joule heat generated in the contacts.

Further, sealing materials 7 can prevent foreign matter from entering housing 9 from the outside through between housing 9 and fixed terminal 21.

Electromagnetic relay 1 is equipped with, for example, an electric vehicle or the like. Electromagnetic relay 1 switches, for example, presence or absence of supply of a current from a power source to a motor of an electric vehicle.

A more specific exemplary embodiment of electromagnetic relay 1 will be described. In the following description, a direction in which fixed contact 22 and movable contact 25 are disposed side by side is defined as an up-down direction, a direction to a side of fixed contact 22 as viewed from movable contact 25 is upward, and a direction to a side of movable contact 25 as viewed from fixed contact 22 is downward. A direction in which first fixed contact 221 and second fixed contact 222 are disposed side by side is defined as a right-left direction, a direction to a side of second fixed contact 222 as viewed from first fixed contact 221 is left, and a direction to a side of first fixed contact 221 as viewed from second fixed contact 222 is right. When the left for an observer is a leftward direction and the right for the observer is a rightward direction, a forward direction for the observer is referred to as front, a backward direction for the observer is back, and a direction including the front and the back is referred to as a front-back direction. Unless otherwise stated, upper, lower, front, back, left, and right in the following description are defined based on orientations and directions described above. It should be noted that these orientations and directions are for convenience of describing a structure of electromagnetic relay 1 according to the present exemplary embodiment, and do not specify the orientation of electromagnetic relay 1 or the like when electromagnetic relay 1 is used. Also, the following exemplary embodiments are just examples of various exemplary embodiments of the present disclosure. The following exemplary embodiment can be variously modified according to design and the like as long as an object of the present disclosure can be achieved. Each figure described in the following exemplary embodiments is a schematic view, and a ratio of a size and a thickness of each component in the figure do not necessarily reflect an actual dimensional ratio.

### First Exemplary Embodiment

A first exemplary embodiment will be described with reference to FIGS. 1 to 5. Electromagnetic relay 1 according to the first exemplary embodiment includes contact point device 2, electromagnet device 5, and housing 9. Housing 9 contains interior parts including contact point device 2 and electromagnet device 5.

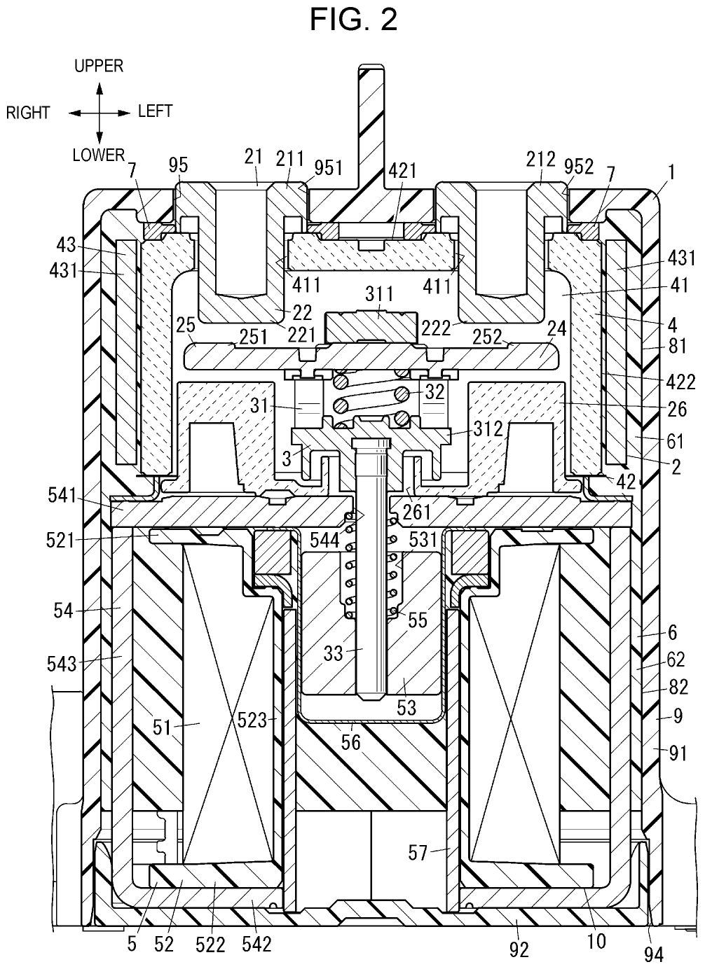

The interior parts will be described (particularly, see FIG. 2).

Contact point device 2 includes fixed terminal 21, movable contactor 24, contact container 4, and movable portion 3.

Fixed terminal 21 has fixed contact 22. In the first exemplary embodiment, fixed terminal 21 includes first fixed terminal 211 and second fixed terminal 212, and fixed contact 22 includes first fixed contact 221 and second fixed contact 222. First fixed terminal 211 has first fixed contact 221 and second fixed terminal 212 has second fixed contact 222. Each of first fixed terminal 211 and second fixed terminal 212 is made of a conductive material such as copper. First fixed terminal 211 and second fixed terminal 212 are disposed side by side in the right-left direction, and second fixed terminal 212 is on the left side of first fixed terminal 211. Each of first fixed terminal 211 and second fixed terminal 212 has a cylindrical shape.

At a lower end of first fixed terminal 211, first fixed contact 221 facing downward exists. In the first exemplary embodiment, first fixed terminal 211 is a member integrated with first fixed contact 221, and a lower end portion of first fixed terminal 211 is first fixed contact 221. First fixed terminal 211 may have a member that is a main body of first fixed terminal 211, and first fixed contact 221 that is a member separate from the main body and attached to a lower end of this main body. Further, at a lower end of second fixed terminal 212, second fixed contact 222 facing downward exists. In the first exemplary embodiment, second fixed terminal 212 is a member integrated with second fixed contact 222, and a lower end portion of second fixed terminal 212 is second fixed contact 222. Second fixed terminal 212 may have a member that is a main body of second fixed terminal 212 and second fixed contact 222 that is a member separate from the main body and attached to the lower end of this main body.

Movable contactor 24 is made of a conductive material such as copper. Movable contactor 24 has movable contact 25. In the first exemplary embodiment, movable contact 25 includes first movable contact 251 and second movable contact 252. Movable contactor 24 has a flat plate shape that is long in the right-left direction and has a thickness in the up-down direction. Movable contactor 24 can move in the up-down direction. At two end portions in the right-left direction on an upper surface of movable contactor 24, first movable contact 251 and second movable contact 252 exist. First movable contact 251 is below first fixed contact 221, and first movable contact 251 and first fixed contact 221 face each other in the up-down direction. Second movable contact 252 is below second fixed contact 222, and second movable contact 252 and second fixed contact 222 face each other in the up-down direction. In the first exemplary embodiment, movable contactor 24 is an integral member, and a part of movable contactor 24 is first movable contact 251 and another part is second movable contact 252. Movable contactor 24 may have a flat plate-shaped member that is a main body of movable contactor 24, and first movable contact 251 and second movable contact 252 that are separate from the main body and attached to the main body.

Movable contactor 24 is movable with respect to fixed terminal 21 between the non-contact position where fixed contact 22 is not in contact with movable contact 25 and the contact position where fixed contact 22 is in contact with movable contact 25. In the first exemplary embodiment, at the non-contact position, each of first fixed contact 221 and second fixed contact 222 is in contact with neither first movable contact 251 nor second movable contact 252. At the contact position, first fixed contact 221 and second fixed contact 222 is in contact with first movable contact 251 and second movable contact 252, respectively. Movable contactor 24 moves in the up-down direction between the non-contact position and the contact position.

The “non-contact position” may be referred to as a “first position”, and the “contact position” may be referred to as a “second position”.

Contact container 4 is a container that contains fixed contact 22 of fixed terminal 21 and movable contactor 24. Contact container 4 is made of a non-magnetic heat-resistant material such as ceramic. A shape of contact container 4 is a box shape with a lower surface open. In an upper surface of contact container 4, there are two through holes 411 disposed side by side in the right-left direction. A space inside contact container 4 is containing chamber 41 that contains fixed contact 22 (first fixed contact 221 and second fixed contact 222) and movable contactor 24. Containing chamber 41 is filled with an arc-extinguishing gas such as hydrogen. Each of first fixed terminal 211 and second fixed terminal 212 is passed through each of through holes 411. This allows contact container 4 to contain fixed contact 22 of fixed terminal 21. An upper end of each of first fixed terminal 211 and second fixed terminal 212 protrudes upward from the upper surface of contact container 4. Each of first fixed terminal 211 and second fixed terminal 212 is bonded to contact container 4 by brazing, for example.

Shielding member 26 is also disposed in contact container 4. Shielding member 26 has electrical insulation. Shielding member 26 is made of an electrically insulating material such as ceramic or synthetic resin. Shielding member 26 is disposed below movable contactor 24 in containing chamber 41. Shielding member 26 comes into contact with, and further extends an arc generated between fixed contact 22 and movable contact 25 when the arc is extended under movable contactor 24 through the front or the back of movable contactor 24, and thereby, shielding member 26 can promote shielding of the arc. The arc may be generated between movable contact 25 and fixed contact 22 when movable contactor 24 moves from the contact position to the non-contact position. Shielding member 26 has through hole 261 that penetrates in the up-down direction.

An outer surface of contact container 4 includes first surface 421 that exposes fixed terminal 21 to the outside, and second surface 422 that is connected to this first surface 421 and surrounds an opening of contact container 4, fixed contact 22 (first fixed contact 221 and second fixed contact 222), and movable contactor 24. In the first exemplary embodiment, the upper surface of contact container 4 is first surface 421, and an outer peripheral surface of contact container 4 is second surface 422.

Movable portion 3 includes holder 31 and drive shaft 33.

Holder 31 is disposed in containing chamber 41. Holder 31 has upper wall 311, lower wall 312 connected to upper wall 311, and contact pressure spring 32. Upper wall 311 is above lower wall 312, and upper wall 311 and lower wall 312 face each other at a distance in the up-down direction. Movable contactor 24 is passed between upper wall 311 and lower wall 312. Contact pressure spring 32 is, for example, a compression coil spring. Contact pressure spring 32 is disposed between lower wall 312 and movable contactor 24 in a state where an expansion and contraction direction is the up-down direction. Contact pressure spring 32 applies an upward elastic force to movable contactor 24. That is, contact pressure spring 32 applies an elastic force toward upper wall 311 to movable contactor 24. This allows movable contactor 24 to be held by holder 31 by being sandwiched between upper wall 311 and contact pressure spring 32.

A shape of drive shaft 33 is a round rod shape. An axial direction of drive shaft 33 is along the up-down direction. An upper end of drive shaft 33 is coupled to holder 31. Drive shaft 33 is connected to movable contactor 24 via holder 31. Drive shaft 33 is passed through through hole 261 of shielding member 26. A lower end of drive shaft 33 protrudes below contact container 4.

Electromagnetic relay 1 further includes magnetic flux generator 43. Magnetic flux generator 43 has two permanent magnets 431. Two permanent magnets 431 face each other in the direction in which first fixed contact 221 and second fixed contact 222 are disposed side by side (right-left direction) with contact container 4 sandwiched between them. Two permanent magnets 431 have different poles facing each other. That is, an N pole of one of two permanent magnets 431, and an S pole of the other face each other. Alternatively, two permanent magnets 431 may have the same poles facing each other. Two permanent magnets 431 generate a magnetic flux in the right-left direction in a space between fixed contact 22 and movable contact 25 (a space between first fixed contact 221 and first movable contact 251, and a space between second fixed contact 222 and second movable contact 252). It is preferable that the magnetic flux in the right-left direction exists around fixed contact 22 or around movable contact 25. Magnetic flux generator 43 generates the magnetic flux in containing chamber 41 to thereby extend the arc generated between fixed contact 22 and movable contact 25, which enables quick extinguishing of the arc.

Electromagnet device 5 is below contact container 4 in contact point device 2. Electromagnet device 5 includes exciting coil 51, coil bobbin 52, movable iron core 53, yoke 54, return spring 55, cylindrical member 56, and bush 57. Electromagnet device 5 further includes two coil terminals that both ends of exciting coil 51 are connected to.

Coil bobbin 52 is made of, for example, resin. Exciting coil 51 is wound around coil bobbin 52. Coil bobbin 52 has two flanges 521, 522 and cylindrical portion 523. Cylindrical portion 523 has a cylindrical shape having a central axis in the up-down direction. Exciting coil 51 is wound around cylindrical portion 523. Flange 521 extends outward in a radial direction of cylindrical portion 523 from an upper end of cylindrical portion 523. Flange 522 extends outward in the radial direction of cylindrical portion 523 from a lower end of cylindrical portion 523.

A shape of cylindrical member 56 is a bottomed cylindrical shape having a central axis in the up-down direction and an open upper end. Cylindrical member 56 is contained in cylindrical portion 523.

Movable iron core 53 is made of a magnetic material. Movable iron core 53 is contained in cylindrical member 56. A shape of movable iron core 53 is a cylindrical shape having a central axis in the up-down direction. Movable iron core 53 is formed with recess 531 that is recessed downward from an upper surface of movable iron core 53. Drive shaft 33 of movable portion 3 is passed through recess 531 and a lower end portion of drive shaft 33 is fixed to movable iron core 53.

Yoke 54 is at least a part of a magnetic circuit that the magnetic flux generated in exciting coil 51 passes through when exciting coil 51 is energized. Yoke 54 includes plate-shaped first yoke 541, plate-shaped second yoke 542, and two plate-shaped third yokes 543. First yoke 541 is disposed between movable contactor 24 and exciting coil 51. First yoke 541 is in contact with an upper surface of coil bobbin 52. Second yoke 542 is in contact with a lower surface of coil bobbin 52. Two third yokes 543 extend from both right and left ends of second yoke 542 to first yoke 541. A shape of first yoke 541 is a rectangular plate shape. Insertion hole 544 is formed in a substantially center of first yoke 541. Drive shaft 33 is passed through insertion hole 544.

Return spring 55 is, for example, a compression coil spring. A first end (upper end) of return spring 55 in the expansion and contraction direction (up-down direction) is in contact with first yoke 541, and a second end (lower end) is in contact with a bottom surface of recess 531 of movable iron core 53. Return spring 55 applies a downward elastic force to movable iron core 53.

Bush 57 is made of a magnetic material. A shape of bush 57 is cylindrical. Bush 57 is disposed between an inner peripheral surface of coil bobbin 52 and an outer peripheral surface of cylindrical member 56. Bush 57, together with yoke 54 and movable iron core 53, configures a magnetic circuit that the magnetic flux generated when exciting coil 51 is energized passes through.

Electromagnetic relay 1 further includes joining body 42. A shape of joining body 42 is a rectangular frame shape. Joining body 42 is bonded to contact container 4 by brazing. Further, joining body 42 is bonded to yoke 54 included by electromagnet device 5 by brazing. This allows joining body 42 to join contact container 4 and yoke 54. That is, joining body 42 joins electromagnet device 5 and contact container 4. This closes the opening of contact container 4 by yoke 54. Further, as a result, internal container 10 including electromagnet device 5 and contact container 4 joined to electromagnet device 5 is configured.

Housing 9 will be described.

Housing 9 is made of, for example, resin. Housing 9 includes container 91 and closure 92. Container 91 has opening 94 and contains contact container 4 and electromagnet device 5. In the first exemplary embodiment, opening 94 is open downward. Closure 92 is attached to container 91 to close at least a part (all in the first exemplary embodiment) of opening 94. Opening 94 has a substantially quadrangular shape, and closure 92 has a substantially quadrangular shape corresponding to a shape of opening 94. Container 91 contains interior parts including above-described contact container 4 and electromagnet device 5. This allows housing 9 to contain contact container 4 and electromagnet device 5. In container 91, contact container 4, electromagnet device 5, and opening 94 of container 91 are disposed in order from the upper side. Therefore, closure 92 is located below electromagnet device 5, and electromagnet device 5 and closure 92 face each other in the up-down direction. Thereby, opening 94 is located at a position opposite to contact container 4 with respect to electromagnet device 5, and electromagnet device 5 and contact container 4 are disposed side by side in a direction orthogonal to an opening surface of opening 94.

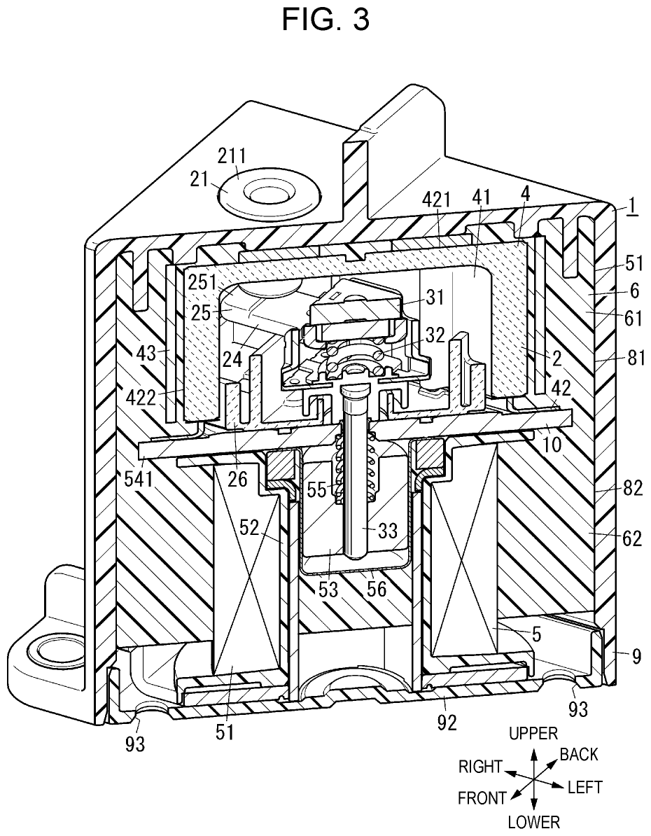

There is a gap (first space 81) between the inner surface of housing 9 and contact container 4. There is also a gap (second space 82) between the inner surface of housing 9 and electromagnet device 5. In first space 81, the parts other than contact container 4, such as permanent magnets 431 of magnetic flux generator 43, may be partially interposed between the inner surface of housing 9 and contact container 4. Also, in second space 82, the parts other than electromagnet device 5 may be partially interposed between the inner surface of housing 9 and electromagnet device 5. In the first exemplary embodiment, first space 81 is adjacent to second space 82, and second space 82 communicates with first space 81 (particularly, see FIG. 3). That is, first space 81 and second space 82 configures one space.

“First space 81” may be referred to as a “first region”, and “second space 82” may be referred to as a “second region”.

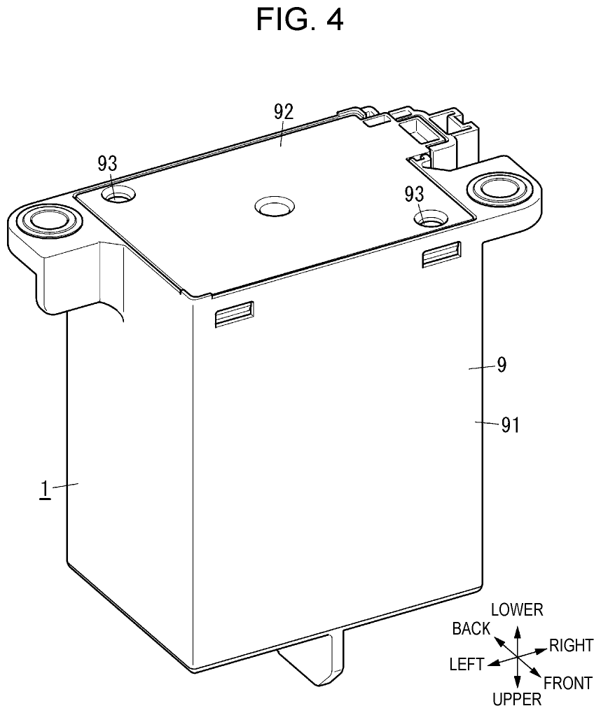

Housing 9 has passing hole 93, and the outside of housing 9 and first space 81 shielded by sealing materials 7 communicate with each other through passing hole 93 (see FIGS. 3 and 4). Housing 9 may have a plurality of passing holes 93. In the first exemplary embodiment, housing 9 has passing holes 93 that penetrate closure 92. Closure 92 has two passing holes 93. Passing holes 93 in the first exemplary embodiment communicate with second space 82, but since second space 82 communicates with first space 81 as described above, passing holes 93 communicate with first space 81 via second space 82. In the first exemplary embodiment, two passing holes 93 in closure 92 are formed at two opposing corners of closure 92, respectively.

Housing 9 has exposure opening 95 that exposes fixed terminal 21 in contact point device 2 to the outside. Exposure opening 95 is provided in a first end portion (upper end portion) of the housing. Passing holes 93 are provided in a second end portion (lower end portion) of the housing facing the opposite side of the first end portion. Specifically, exposure opening 95 includes first exposure opening 951 corresponding to first fixed terminal 211 and second exposure opening 952 corresponding to second fixed terminal 212. First exposure opening 951 and second exposure opening 952 penetrate an upper surface of container 91 in the up-down direction. First exposure opening 951 and second exposure opening 952 are disposed side by side in the right-left direction. A portion of first fixed terminal 211 protruding from contact container 4 is inserted into first exposure opening 951, and thereby, the upper end of first fixed terminal 211 protrudes upward from first exposure opening 951. This allows first fixed terminal 211 to be exposed to the outside of housing 9. There is a gap between first fixed terminal 211 and first exposure opening 951. The outside of housing 9 and first space 81 communicate with each other via the gap of first exposure opening 951. Similarly, a portion of second fixed terminal 212 protruding from contact container 4 is inserted through second exposure opening 952, and thereby, the upper end of second fixed terminal 212 protrudes upward from second exposure opening 952. This allows second fixed terminal 212 to be exposed to the outside of housing 9. There is a gap between second fixed terminal 212 and second exposure opening 952. The outside of housing 9 and first space 81 communicate with each other via the gap of second exposure opening 952.

As described above, electromagnetic relay 1 includes sealing materials 7 that shield first space 81 from the outside of housing 9. Sealing materials 7 are made of an elastic elastomer such as silicone rubber. In the first exemplary embodiment, electromagnetic relay 1 includes two sealing materials 7, sealing material 7 for first fixed terminal 211 and sealing material 7 for second fixed terminal 212. Two sealing materials 7 seal first exposure opening 951 and second exposure opening 952 to prevent first space 81 from communicating with the outside of housing 9. Thereby, sealing materials 7 shield paths communicating between first space 81 and housing 9 via first exposure opening 951 and second exposure opening 952.

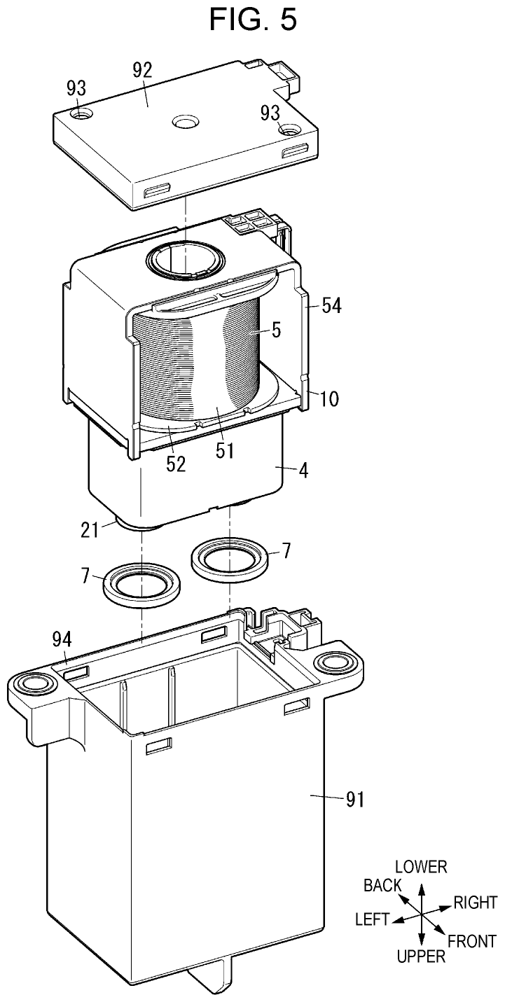

More specifically, each of sealing materials 7 has a ring shape (see FIG. 5). Sealing material 7 for first fixed terminal 211 is in contact with the upper surface of contact container 4 and in contact with an edge of first exposure opening 951 in the inner surface of housing 9 between the upper surface of contact container 4 and the inner surface of housing 9 (inner surface of container 91). It is preferable that sealing material 7 is sandwiched between housing 9 and contact container 4 and is compressively deformed. Sealing material 7 for first fixed terminal 211 surrounds a periphery of first fixed contact 221. Specifically, sealing material 7 surrounds an outer peripheral surface of first fixed contact 221 and is in contact with this outer peripheral surface. Similarly, sealing material 7 for second fixed terminal 212 is in contact with the upper surface of contact container 4 and in contact with an edge of second exposure opening 952 in the inner surface of housing 9 between the upper surface of contact container 4 and the inner surface of housing 9 (inner surface of container 91). It is preferable that sealing material 7 is sandwiched between housing 9 and contact container 4 and is compressively deformed. Sealing material 7 for second fixed terminal 212 surrounds a periphery of second fixed contact 222. Specifically, it surrounds an outer peripheral surface of second fixed contact 222 and is in contact with the outer peripheral surface.

Further, by disposing sealing material 7 in the gap between housing 9 and fixed terminal 21 in exposure opening 95, sealing material 7 may shield first space 81 from the outside of housing 9.

Heat conductive member 6 only needs to be a member having a higher thermal conductivity than air. Heat conductive member 6 is made of, for example, resin. Heat conductive member 6 is manufactured, for example, by reacting and curing a two-pack type urethane resin composition. Heat conductive member 6 is disposed in first space 81 as described above. In the first exemplary embodiment, heat conductive member 6 is also disposed in second space 82. Heat conductive member 6 may be disposed in entire first space 81, or may be disposed in a part of first space 81. Further, heat conductive member 6 may be disposed in entire second space 82, or may be disposed in a part of second space 82.

Heat conductive member 6 includes first portion 61 disposed in first space 81 and second portion 62 disposed in second space 82. First portion 61 and second portion 62 are continuously connected. That is, each of first portion 61 and second portion 62 is a part of heat conductive member 6 that is one member. In this case, first portion 61 may be disposed in entire first space 81, or may be disposed in a part of first space 81. Further, second portion 62 may be disposed in entire second space 82, or may be disposed in a part of second space 82.

It is preferable that in first space 81, heat conductive member 6 (first portion 61) is in contact with contact container 4 and also in contact with the inner surface of housing 9. In this case, heat generated in the contacts is easily released from contact container 4 to the outside of electromagnetic relay 1 via heat conductive member 6 and housing 9.

It is preferable that in second space 82, heat conductive member 6 (second portion 62) is in contact with electromagnet device 5 and also in contact with the inner surface of housing 9. In this case, heat generated by electromagnet device 5 is easily released to the outside of electromagnetic relay 1 via heat conductive member 6 and housing 9. Specifically, second space 82 includes a region between housing 9 and yoke 54 and a region between exciting coil 51 and yoke 54. It is preferable that heat conductive member 6 is disposed in at least one of the region between housing 9 and yoke 54 and the region between exciting coil 51 and yoke 54, and it is more preferable that heat conductive member 6 is disposed in both. Further, heat conductive member 6 may be disposed between two flanges 521, 522 of coil bobbin 52.

Here, first space 81 in the first exemplary embodiment is a region between the outer surface of contact container 4 and the inner surface of a portion surrounding contact container 4 in housing 9. As described above, the outer surface of contact container 4 includes first surface 421 and second surface 422. Therefore, first space 81 includes a region between first surface 421 and the inner surface of housing 9, and a region between second surface 422 and the inner surface of housing 9. It is preferable that heat conductive member 6 (first portion 61) is disposed in at least one of the region between first surface 421 and the inner surface of housing 9 and the region between second surface 422 and the inner surface of housing 9, and it is more preferable that it is disposed in both. In this case, the heat generated in the contacts is particularly easily released from contact container 4 to the outside of electromagnetic relay 1 via heat conductive member 6 and housing 9.

Operation of electromagnetic relay 1 according to the first exemplary embodiment will be described.

When electromagnet device 5 generates an electromagnetic force that drives movable portion 3, the driving of movable portion 3 causes movable portion 3 to move movable contactor 24 from the non-contact position to the contact position.

Specifically, when exciting coil 51 of electromagnet device 5 is energized, the magnetic flux generated by exciting coil 51 passes through the magnetic circuit, so that an electromagnetic force is generated that moves movable iron core 53 upward to reduce a magnetic resistance of the magnetic circuit. When this electromagnetic force exceeds the force (elastic force) of return spring 55 that pushes movable iron core 53 downward, movable iron core 53 moves upward to fill the gap between first yoke 541 and the upper end of movable iron core 53 in the magnetic circuit. Thereby, electromagnet device 5 drives movable portion 3.

When movable iron core 53 moves upward, drive shaft 33 and holder 31 in movable portion 3 also rise. Along with this, movable contactor 24 held in holder 31 moves upward. As a result, movable contactor 24 is located at the contact position. This allows first fixed contact 221 and second fixed contact 222 to be electrically connected via movable contactor 24. That is, first fixed terminal 211 and second fixed terminal 212 are electrically connected.

When movable contactor 24 is at the contact position, if exciting coil 51 enters a state not energized from a state energized, the electromagnetic force that moves movable iron core 53 upward disappears, so that movable iron core 53 moves downward due to the elastic force of return spring 55. As a result, movable contactor 24 moves downward, and movable contactor 24 is located at the non-contact position. This brings about the state where first fixed terminal 211 and second fixed terminal 212 are not electrically connected.

When a voltage is applied between first fixed terminal 211 and second fixed terminal 212 when movable contactor 24 is at the contact position, Joule heat is generated by currents flowing between first fixed terminal 211 and movable contactor 24 and between movable contactor 24 and second fixed terminal 212. In the first exemplary embodiment, the Joule heat is easily released from contact container 4 to the outside of electromagnetic relay 1 through heat conductive member 6 and housing 9. Therefore, temperatures of movable contactor 24 and fixed terminal 21 are hard to become excessively high, and as a result, the operation of electromagnetic relay 1 is easily stabilized.

Further, when heat conductive member 6 or its raw material is disposed in first space 81 shielded by sealing materials 7, sealing materials 7 can make it hard for heat conductive member 6 or its raw material to leak out from first space 81 to the outside of housing 9. Therefore, heat conductive member 6 that fills first space 81 is easily manufactured. Therefore, in the first exemplary embodiment, it is possible to easily obtain electromagnetic relay 1 that easily releases the Joule heat generated in the contacts.

An example of a method for manufacturing heat conductive member 6 in the first exemplary embodiment will be described with reference to FIG. 5.

Container 91, closure 92, sealing materials 7, and the interior parts (internal container 10 and the like) are prepared. In FIG. 5, the interior parts other than internal container 10 are omitted.

First, the interior parts including internal container 10 are put into container 91 from opening 94 of container 91. At this time, sealing materials 7 are disposed at the positions as described above between internal container 10 and container 91. Thereby, sealing materials 7 shield first space 81 from the outside of housing 9.

Subsequently, closure 92 is attached to container 91, and opening 94 is closed by closure 92. In this state, heat conductive member 6 is not disposed in first space 81 and second space 82. Thereby, an intermediate product of electromagnetic relay 1 without heat conductive member 6 can be obtained.

Next, the intermediate product is disposed in a state where the intermediate product is turned upside down from the above description, that is, in a state where opening 94 of container 91 faces upward. In this state, the raw material of heat conductive member 6 is put into housing 9 from only one of two passing holes 93 of housing 9 (i.e., two passing holes 93 penetrating closure 92). The raw material of heat conductive member 6 is, for example, a fluid reaction-curable resin composition, for example, a two-pack type urethane resin composition. It is a so-called potting agent. In this case, as the raw material of heat conductive member 6 is put into housing 9 from the one of passing holes 93, gas such as air in housing 9 is easily discharged from the other of passing holes 93 to the outside of housing 9. Therefore, the raw material of the heat conductive member can be easily put into housing 9. The raw material of heat conductive member 6 is put into housing 9, for example, until this raw material fills entire first space 81 and the raw material further fills a part or all of second space 82. An amount of the raw material inside housing 9 can be confirmed by observing the inside of housing 9 through passing hole 93.

When the raw material is put into housing 9, fixed terminal 21 faces downward. Therefore, if there is a gap between housing 9 and fixed terminal 21, there is a risk that the raw material leaks out from this gap. However, in the first exemplary embodiment, as described above, sealing materials 7 shield the paths communicating between first space 81 and the outside of housing 9 via exposure opening 95 even before the raw material is put into housing 9. Therefore, it is hard for the raw material to leak out from the gap between fixed terminal 21 and exposure opening 95, and thus, the raw material is easily disposed in first space 81.

Subsequently, the raw material inside housing 9 is reacted and cured by heating or the like, if necessary. Thereby, heat conductive member 6 made of a cured product of the raw material is manufactured.

### Second Exemplary Embodiment

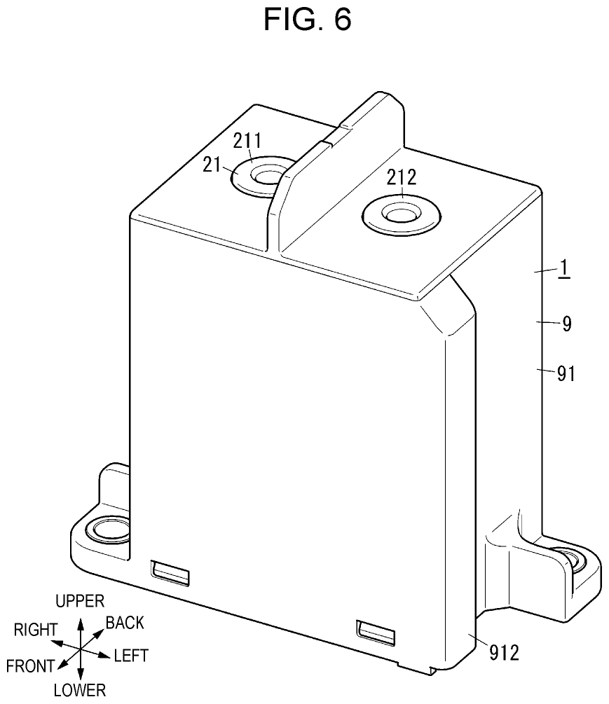

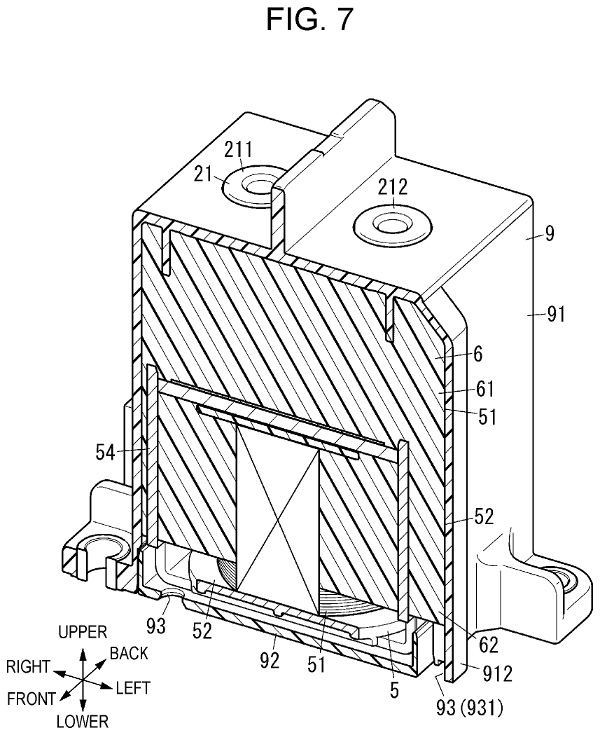

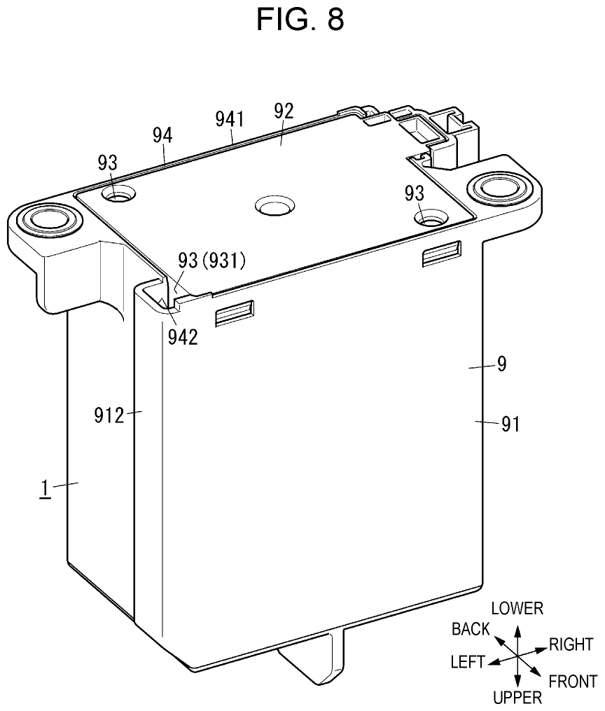

A second exemplary embodiment will be described with reference to FIGS. 6 to 9. In electromagnetic relay 1 according to the second exemplary embodiment, housing 9 has a passing hole 93 (hereinafter referred to as expansion passing hole 931) that is surrounded by a part of an inner peripheral edge of opening 94 of container 91 and a part of an outer peripheral edge of closure 92, and communicates the outside of housing 9 and the space (first space 81) (see FIGS. 7 and 8). Other configurations than the foregoing are the same as those of the first exemplary embodiment.

The second exemplary embodiment will be described in more detail. The same configurations as those in the first exemplary embodiment will be designated by the same reference marks as those in the first exemplary embodiment in the drawings, and description thereof will be omitted as appropriate.

Housing 9 in the second exemplary embodiment includes container 91 and closure 92. Particularly, housing 9 includes a hollow box-shaped container 91 having opening 94 that opens downward, and closure 92 attached to container 91 to close a part of opening 94 of container 91.

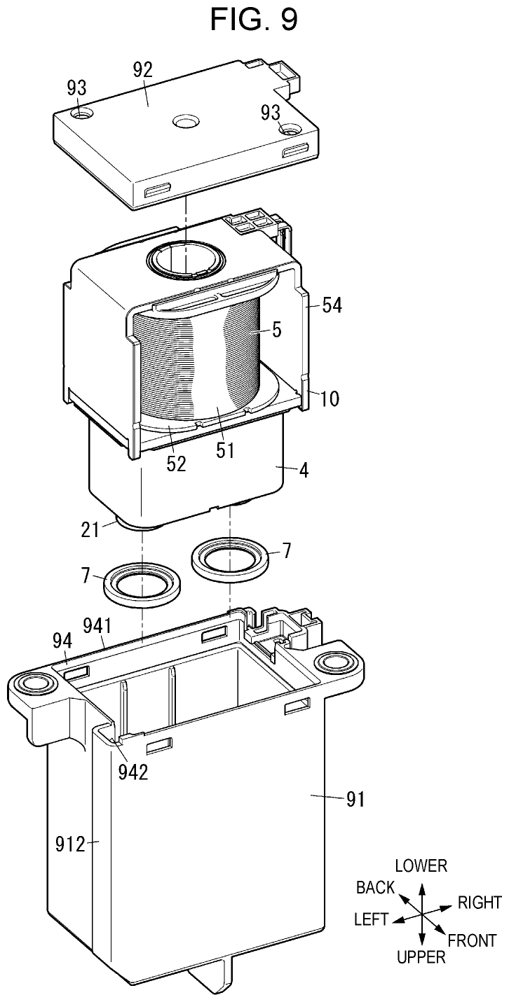

An outer peripheral surface of container 91 includes expanded portion 912 protruding in one direction (left) orthogonal to the opening surface of opening 94 on the lower surface of container 91 (see FIG. 6). On a lower surface of expanded portion 912, there is expansion opening portion 942 that configures a part of opening 94 of container 91 (see FIGS. 8 and 9). Thereby, opening 94 in the second exemplary embodiment has quadrangular main opening portion 941 similar to opening 94 in the first exemplary embodiment, and expansion opening portion 942 that is connected to main opening portion 941 and protrudes from main opening portion 941 in the one direction orthogonal to the opening surface of opening 94.

Closure 92 in the second exemplary embodiment has a quadrangular shape corresponding to the shape of main opening portion 941. Closure 92 closes main opening portion 941 that is a part of opening 94, and is attached to container 91 with expansion opening portion 942 not closed.

In the second exemplary embodiment, housing 9 has passing holes 93 that allow the outside of housing 9 to communicate with first space 81. In the second exemplary embodiment, housing 9 has three passing holes 93. In the second exemplary embodiment, housing 9 similar to the first exemplary embodiment has two passing holes 93 penetrating closure 92. Further, housing 9 has expansion passing hole 931 configured with expansion opening portion 942 described above. Expansion passing hole 931 is surrounded by an edge of expansion opening portion 942 that is a part of the inner peripheral edge of opening 94 of container 91, and a part of the outer peripheral edge of closure 92. Expansion passing hole 931 also communicates with second space 82 as with the passing holes 93 other than expansion passing hole 931. However, since second space 82 communicates with first space 81, expansion passing hole 931 communicates with first space 81 via second space 82.

An example of a method for manufacturing heat conductive member 6 in the second exemplary embodiment will be described with reference to FIG. 9.

Container 91, closure 92, sealing materials 7, and the interior parts (internal container 10 and the like) are prepared. In FIG. 9, the interior parts other than internal container 10 are omitted.

Similar to the first exemplary embodiment, first, the interior parts including internal container 10 are put into container 91 from opening 94 of container 91. At this time, sealing materials 7 are disposed at the positions as described above between internal container 10 and container 91. Thereby, sealing materials 7 shield first space 81 from the outside of housing 9 for first space 81 not to communicate with the outside of housing 9 via exposure opening 95.

Subsequently, closure 92 is attached to container 91, and opening 94 is closed by closure 92. In this state, heat conductive member 6 is not disposed in first space 81 and second space 82. Thereby, an intermediate product of electromagnetic relay 1 without heat conductive member 6 can be obtained.

Next, the intermediate product is disposed in a state where the intermediate product is turned upside down from the above description, that is, in a state where opening 94 of container 91 faces upward. In this state, the raw material of heat conductive member 6 is put into housing 9 from one or two passing holes 93 of three passing holes 93 (i.e., two passing holes 93 penetrating closure 92, and expansion passing hole 931) of housing 9. In this case, as the raw material of heat conductive member 6 is put into housing 9 through one or two passing holes 93, gas in housing 9 is easily discharged from remaining passing hole 93 to the outside of housing 9. Therefore, the raw material of the heat conductive member can be easily put into housing 9. The raw material of heat conductive member 6 is put into housing 9, for example, until this raw material fills entire first space 81 and the raw material further fills a part or all of second space 82. An amount of the raw material inside housing 9 can be confirmed by observing the inside of housing 9 through passing hole 93. In particular, when expansion passing hole 931 is located at a position where the amount of the raw material can be easily confirmed, the amount of the raw material can be easily confirmed by using expansion passing hole 931.

Also, in the second exemplary embodiment, when the raw material is put into housing 9, sealing materials 7 shield first space 81 between housing 9 and fixed terminal 21 from the outside of housing 9, and thus, the raw material does not easily leak out between housing 9 and fixed terminal 21 from the gap. Therefore, the raw material is easily disposed in first space 81.

Subsequently, the raw material inside housing 9 is reacted and cured by heating or the like, if necessary. Thereby, heat conductive member 6 made of a cured product of the raw material is manufactured.

The present disclosure is not limited to the above exemplary embodiments. For example, the present disclosure may include a modification obtained by modifying the specific configuration in the above exemplary embodiments. A modification of the present disclosure is described below. In the following, the same configurations as those in the above-described exemplary embodiments will be designated by the same reference marks, and detailed description thereof will be omitted as appropriate.

While in the first exemplary embodiment and the second exemplary embodiment, heat conductive member 6 is disposed in first space 81 and second space 82, heat conductive member 6 is disposed only in first space 81. Further, it is preferable that heat conductive member 6 fills entire first space 81, but may fill only a part of first space 81. However, as described above, it is preferable that heat conductive member 6 is disposed in at least one of the region between first surface 421 and the inner surface of housing 9 and the region between second surface 422 and the inner surface of housing 9, and it is more preferable that heat conductive member 6 is disposed in both.

It is preferable that heat conductive member 6 is in contact with at least one of the inner surface of housing 9 and the outer surface of contact container 4, and it is more preferable that heat conductive member 6 is in contact with both as in the above exemplary embodiments. However, heat conductive member 6 may be in contact with neither the inner surface of housing 9 nor the outer surface of contact container 4.

The configuration of contact container 4 is not limited to the above exemplary embodiments as long as it contains fixed contact 22 of fixed terminal 21, and movable contactor 24. Further, the configuration of movable portion 3 is not limited to the above exemplary embodiments as long as it can be driven by electromagnet device 5 and move movable contactor 24. Movable portion 3 can be configured with a combination of appropriate mechanical elements that transmit power for moving movable contactor 24 from electromagnet device 5 to movable contactor 24.

In the above exemplary embodiments, each of sealing materials 7 has a ring shape, but sealing material 7 may have an appropriate shape in accordance with the shape of fixed terminal 21 or the like. Further, while sealing material 7 is an elastomer in the above exemplary embodiments, sealing material 7 may be a hard member as long as it can shield first space 81 from the outside of housing 9.

While in the second exemplary embodiment, housing 9 has the plurality of passing holes 93, housing 9 may have only one passing hole 93. In that case, housing 9 may have, for example, only one passing hole 93 penetrating closure 92, or only expansion passing hole 931.

A position of passing hole 93 may be any position as long as passing hole 93 communicates with first space 81. For example, passing hole 93 may be on a side surface of housing 9. Further, while in the above exemplary embodiments, passing hole 93 communicates with first space 81 via second space 82, passing hole 93 may directly communicate with first space 81.

While in the above exemplary embodiments, housing 9 is a combination of one container 91 and one closure 92, housing 9 may be a combination of three or more members. For example, container 91 in the above exemplary embodiments may be a combination of a box-shaped member that opens downward, and a tubular member attached to this member.

Electromagnetic relay 1 according to the present disclosure has a remarkable action of easily releasing the Joule heat generated in the contacts, particularly when a large current is passed through electromagnetic relay 1. However, application of electromagnetic relay 1 according to the present disclosure is not limited to the flow of a large current. Regardless of a value of the current flowing through electromagnetic relay 1, in the present disclosure, the action of easily releasing the Joule heat generated in the contacts can be attained.

While in the above exemplary embodiments, exposure opening 95 is a round hole, exposure opening 95 may have any shape as long as it can expose fixed terminal 21 to the outside of housing 9. Further, exposure opening 95 is not limited to the hole, and may have a notch shape, for example.

The present disclosure includes not only the above-described exemplary embodiments and modifications, but also combinations of the above-described exemplary embodiments and modifications.

### CONCLUSION

As is clear from the above-described exemplary embodiments and modifications, electromagnetic relay 1 according to a first aspect of the present disclosure includes fixed terminal 21 having fixed contact 22, movable contactor 24 having movable contact 25, movable portion 3 that moves movable contactor 24 between a first position (non-contact position) and a second position (contact position), electromagnet device 5 that drives movable portion 3, contact container 4 that contains fixed contact 22 and movable contact 25, housing 9 that contains contact container 4 and has exposure opening 95, sealing material 7 disposed in a path communicating with an outside of electromagnetic relay 1, the path being between housing 9 and contact container 4, and a heat conductive member disposed in a first region (first space 81) surrounded by contact container 4, housing 9, and sealing material 7. When movable contactor 24 is at a non-contact position, fixed contact 22 is not in contact with movable contact 25, and when movable contactor 24 is at a contact position, fixed contact 22 is in contact with movable contact 25, and a part of fixed terminal 21 is exposed to an outside from exposure opening 95.

According to this aspect, even if fixed contact 22 and movable contact 25 are conducted at the contact position to generate Joule heat, the Joule heat is easily released from contact container 4 to the outside of electromagnetic relay 1 through heat conductive member 6 and housing 9. Further, sealing material 7 can make it hard for heat conductive member 6 or a raw material of heat conductive member 6 to leak out from first space 81 to the outside of housing 9 when heat conductive member 6 or its raw material is disposed in first space 81.

In electromagnetic relay 1 according to another aspect, housing 9 contains contact container 4 and electromagnet device 5, and heat conductive member 6 is further disposed in a second region (second space 82) located between housing 9 and electromagnet device 5.

According to this aspect, the heat generated by electromagnet device 5 is also easily released to the outside of electromagnetic relay 1 through heat conductive member 6 and housing 9.

In electromagnetic relay 1 according to another aspect, the second region (second space 82) communicates with the first region (first space 81), and a portion (first portion 61) of heat conductive member 6 disposed in the first region (first space 81) and a portion (second portion 62) of heat conductive member 6 disposed in the second region (second space 82) are connected.

According to this aspect, heat conductive member 6 exists from first space 81 to second space 82, and this makes it easier to release the heat from electromagnetic relay 1.

In electromagnetic relay 1 according to another aspect, electromagnet device 5 includes exciting coil 51, coil bobbin 52 that exciting coil 51 is wound around, and yoke 54 that configures a magnetic circuit that a magnetic flux generated by energization of exciting coil 51 passes through. Heat conductive member 6 is disposed between housing 9 and yoke 54 in the second region (second space 82), and heat conductive member 6 is further disposed between exciting coil 51 and yoke 54.

According to this aspect, the heat is more easily released from electromagnetic relay 1 through heat conductive member 6.

In electromagnetic relay 1 according to another aspect, heat conductive member 6 is made of resin.

According to this aspect, heat conductive member 6 is easily formed in the first region (first space 81).

In another aspect of the electromagnetic relay 1, housing 9 has passing hole 93. An outside of housing 9 and the first region (space 81) communicate with each other via passing hole 93.

According to this aspect, since the raw material of heat conductive member 6 can be put into the first region (space 81) from the outside of housing 9 through passing hole 93, and then heat conductive member 6 can be manufactured inside the first region (space 81), it is easy to manufacture heat conductive member 6. Therefore, it is easy to achieve electromagnetic relay 1 having heat conductive member 6.

In electromagnetic relay 1 according to another aspect, exposure opening 95 is provided in a first end portion (upper side in FIG. 1) of housing 9, and passing hole 93 is provided in a second end portion (lower side in FIG. 1) of housing 9 on an opposite side of the first end portion.

According to this aspect, when heat conductive member 6 is manufactured, the raw material of heat conductive member 6 is put into housing 9 from passing hole 93 with exposure opening 95 facing downward, and with passing hole 93 facing upward, so that it becomes easier to supply the raw material to first space 81.

In electromagnetic relay 1 according to another aspect, housing 9 has a plurality of passing holes 93.

According to this aspect, when heat conductive member 6 is manufactured, the raw material of heat conductive member 6 can be put into housing 9 by using any of the plurality of passing holes 93. Further, remaining passing hole 93 can be used to promote discharging of gas inside housing 9 and promote inflow of the raw material into housing 9.

In electromagnetic relay 1 according to another aspect, housing 9 includes container 91 that contains contact container 4 and electromagnet device 5, and closure 92 attached to container 91. Container 91 has opening 94, and closure 92 is provided to close at least a part of opening 94.

According to this aspect, when heat conductive member 6 is manufactured, after contact container 4 and electromagnet device 5 are contained inside container 91 from opening 94, heat conductive member 6 can be disposed inside housing 9.

In electromagnetic relay 1 according to another aspect, electromagnet device 5 is located between opening 94 and contact container 4, and electromagnet device 5 and contact container 4 are disposed side by side along a direction orthogonal to an opening surface of opening 94.

In electromagnetic relay 1 according to another aspect, closure 92 has passing hole 93 that communicates the outside of housing 9 and the first region (first space 81) with each other.

According to this aspect, after opening 94 of container 91 is closed by closure 92, the raw material of heat conductive member 6 can be put into housing 9 by using passing hole 93.

In electromagnetic relay 1 according to another aspect, housing 9 has expansion passing hole 931 that communicates the outside of housing 9 and the first region (first space 81) with each other, expansion passing hole 931 surrounded by a part of an inner peripheral edge of opening 94 of container 91, and a part of an outer peripheral edge of closure 92.

According to this aspect, after opening 94 of container 91 is closed by closure 92, the raw material of heat conductive member 6 can be put into housing 9 by using passing hole 93.

In electromagnetic relay 1 according to another aspect, sealing material 7 surrounds fixed terminal 21.

According to this aspect, sealing material 7 can shield first space 81 from the outside of housing 9 to prevent first space 81 from communicating with the outside of housing 9 via a gap between exposure opening 95 and fixed terminal 21.

In electromagnetic relay 1 according to another aspect, sealing material 7 is sandwiched between housing 9 and contact container 4.

According to this aspect, sealing material 7 can shield first space 81 from the outside of housing 9 to prevent first space 81 from communicating with the outside of housing 9 via the gap between housing 9 and contact container 4.

In electromagnetic relay 1 according to another aspect, fixed terminal 21 includes first fixed terminal 211 and second fixed terminal 212, fixed contact 22 includes first fixed contact 221 included in first fixed terminal 211 and second fixed contact 222 included in second fixed terminal 212, and movable contact 25 includes first movable contact 251 and second movable contact 252. When movable contactor 24 is at the non-contact position, first fixed contact 221 is not in contact with first movable contact 251, and second fixed contact 222 is not in contact with second movable contact 252. When movable contactor 24 is at the contact position, first fixed contact 221 is in contact with first movable contact 251, and second fixed contact 222 is in contact with second movable contact 252. Movable portion 3 moves movable contactor 24 in one direction between the non-contact position and the contact position.

### REFERENCE MARKS IN THE DRAWINGS

1: electromagnetic relay
21: fixed terminal
211: first fixed terminal
212: second fixed terminal
22: fixed contact
221: first fixed contact
222: second fixed contact
24: movable contactor
25: movable contact
251: first movable contact
252: second movable contact
26: shielding member
261: through hole
3: movable portion
31: holder
311: upper wall
312: lower wall
33: drive shaft
4: contact container
41: containing chamber
411: through hole
42: joining body
421: first surface
422: second surface
43: magnetic flux generator
431: permanent magnet
5: electromagnet device
51: exciting coil
52: coil bobbin
521, 522: flange
523: cylindrical portion
53: movable iron core
531: recess
54, 541, 542, 543: yoke
544: insertion hole
56: cylindrical member
57: bush
6: heat conductive member
61: first portion
62: second portion
7: sealing material
81: first space (first region)
82: second space (second region)
9: housing
91: container
912: expanded portion
92: closure
93: passing hole (first passing hole)
931: expansion passing hole (second passing hole)
94: opening (second opening)
941: main opening portion
942: expansion opening portion
95: exposure opening (first opening)
951, 952: exposure opening (first opening)
10: internal container

1. An electromagnetic relay comprising:
a fixed terminal having a fixed contact;
a movable contactor having a movable contact;
a movable portion that moves the movable contactor between a first position and a second position;
an electromagnet device that drives the movable portion;
a contact container that contains the fixed contact and the movable contact;
a housing that contains the contact container and has a first opening;
a sealing material disposed in a path communicating with an outside of the electromagnetic relay, the path being between the housing and the contact container; and
a heat conductive member disposed in a first region surrounded by the contact container, the housing, and the sealing material, wherein
when the movable contactor is at the first position, the fixed contact is not in contact with the movable contact,
when the movable contactor is at the second position, the fixed contact is in contact with the movable contact, and
a part of the fixed terminal is exposed to the outside from the first opening.

2. The electromagnetic relay according to claim 1, wherein
the housing contains the contact container and the electromagnet device, and
the heat conductive member is further disposed in a second region located between the housing and the electromagnet device.

3. The electromagnetic relay according to claim 2, wherein
the second region communicates with the first region, and
a portion of the heat conductive member disposed in the first region and a portion of the heat conductive member disposed in the second region are connected.

4. The electromagnetic relay according to claim 2, wherein
the electromagnet device includes an exciting coil, a coil bobbin that the exciting coil is wound around, and a yoke that configures a magnetic circuit that a magnetic flux generated by energization of the exciting coil passes through,
the heat conductive member is disposed between the housing and the yoke in the second region, and
the heat conductive member is further disposed between the exciting coil and the yoke.

5. The electromagnetic relay according to claim 1, wherein the heat conductive member is made of resin.

6. The electromagnetic relay according to claim 1, wherein
the housing has a first passing hole, and
an outside of the housing and the first region communicate with each other via the first passing hole.

7. The electromagnetic relay according to claim 6, wherein
the first opening is provided in a first end portion of the housing, and
the first passing hole is provided in a second end portion of the housing on an opposite side of the first end portion.

8. The electromagnetic relay according to claim 6, wherein
the housing has a plurality of passing holes, and
the first passing hole is one of the plurality of passing holes.

9. The electromagnetic relay according to claim 1, wherein
the housing includes:
a container that contains the contact container and the electromagnet device; and
a closure attached to the container,
the container has a second opening, and
the closure is provided to close at least a part of the second opening.

10. The electromagnetic relay according to claim 9, wherein
the electromagnet device is located between the second opening and the contact container, and
the electromagnet device and the contact container are disposed side by side along a direction orthogonal to an opening surface of the second opening.

11. The electromagnetic relay according to claim 9, wherein the closure has the first passing hole that communicates the outside of the housing and the first region with each other.

12. The electromagnetic relay according to claim 1, wherein the housing has a second passing hole that communicates the outside of the housing and the first region with each other, the second passing hole surrounded by a part of an inner peripheral edge of the second opening of the container, and a part of an outer peripheral edge of the closure.

13. The electromagnetic relay according to claim 1, wherein the sealing material surrounds the fixed terminal.

14. The electromagnetic relay according to claim 1, wherein the sealing material is sandwiched between the housing and the contact container.

15. The electromagnetic relay according to claim 1, wherein
the fixed terminal includes a first fixed terminal and a second fixed terminal,
the fixed contact includes a first fixed contact included in the first fixed terminal and a second fixed contact included in the second fixed terminal,
the movable contact includes a first movable contact and a second movable contact,
when the movable contactor is at the first position, the first fixed contact is not in contact with the first movable contact, and the second fixed contact is not in contact with the second movable contact,
when the movable contactor is at the second position, the first fixed contact is in contact with the first movable contact, and the second fixed contact is in contact with the second movable contact, and
the movable portion moves the movable contactor in one direction between the first position and the second position.
